(19) United States
(12) Patent Application Publication
(10) Pub. No.: US 2026/0127652 A1
(43) Pub. Date: May 7, 2026

(54) GENERATIVE ARTIFICIAL INTELLIGENCE-ENABLED AND AUGMENTED USER RESEARCH USING SYNTHETIC PERSONAS AS SUBJECTS

(71) Applicant: INTERNATIONAL BUSINESS MACHINES CORPORATION, ARMONK, NY (US)

(72) Inventors: Jennifer M. Hatfield, Portland, OR (US); Lucia Larise Stavarache, Columbus, OH (US); Michael Jack Martine, Chapel Hill, NC (US); Sarah Diane Green, Chandler, AZ (US); Mark J. Ludlow, Fairfield, CT (US); Ira L. Allen, Dallas, TX (US)

(21) Appl. No.: 18/937,616

(22) Filed: Nov. 5, 2024

(51) Int. Cl. G06Q 30/0601; G06N 3/092

(52) U.S. Cl. CPC G06Q 30/0631; G06N 3/092

(57) ABSTRACT

An approach is provided for generative artificial intelligence (GenAI)-enabled user research using synthetic personas. Data for user research for a product or service is collected. The data is included in categories of individual profile data for users, product feature data, company metadata, and historical data. The collected data is evaluated using a neural network. Scores for types of data in each category are determined based on the evaluated data. An overall fit score is determined by aggregating the scores. Based on the overall fit score, a recommendation of areas of focus is generated. The areas of focus are associated with the product or service and require an evaluation. One or more synthetic personas are generated based on the individual profile data. The evaluation of the areas of focus is performed by using the one or more synthetic personas.

### BACKGROUND

The present invention relates to user research, and more particularly to user research enhanced by generative artificial intelligence (GenAI).

### SUMMARY

In one embodiment, the present invention provides a computer-implemented method. The method includes collecting data for user research for a product or a service. The data is included in a first category of individual profile data for a plurality of users, a second category of product feature data, a third category of company metadata, and a fourth category of historical data. The method further includes evaluating the collected data using a neural network. The method further includes determining scores for types of data in each category based on the evaluated data. The method further includes determining an overall fit score by aggregating the scores. The method further includes, based on the overall fit score, generating a recommendation of areas of focus associated with the product or service that require an evaluation. The method further includes generating, by a processor set, one or more synthetic personas based on the individual profile data. The method further includes performing the evaluation of the areas of focus by using the one or more synthetic personas.

In one embodiment, the present invention provides another computer-implemented method. The method includes defining an initial subject for user research. The initial subject is required to be evaluated in the user research. The method further includes identifying user characteristics that one or more users are required to have to evaluate the initial subject. The user characteristics include (i) levels of experience and expertise associated with using the product or the service, (ii) cultural backgrounds of the one or more users, and (iii) learning and thinking modalities of the one or more users. The method further includes identifying one or more synthetic personas whose characteristics match the identified user characteristics. The method further includes collecting feedback about the initial subject from the one or more synthetic personas. The method further includes receiving a validation of the collected feedback from a user group consisting of humans. The method further includes, based on the collected feedback and in response to receiving the validation, updating the initial subject to generate an updated subject. The method further includes repeating the defining, the identifying the user characteristics, the identifying the one or more synthetic personas, the collecting the feedback, and the receiving the validation, with the initial subject being replaced by the updated subject.

Respective computer systems and computer program products corresponding to the above-summarized computer-implemented methods are also described herein.

### BRIEF DESCRIPTION OF THE DRAWINGS

FIG. 1 is a block diagram of a system for GenAI-enabled and augmented user research using synthetic personas as subjects, in accordance with embodiments of the present invention.

FIG. 2 is a block diagram of a first set of modules included in code included in the system of FIG. 1, in accordance with embodiments of the present invention.

FIG. 3 is a flowchart of a process of GenAI-enabled and augmented user research using synthetic personas as subjects, where operations of the flowchart are performed by modules in FIG. 2, in accordance with embodiments of the present invention.

FIG. 4 is a block diagram of a system that implements the process of FIG. 3, in accordance with embodiments of the present invention.

FIG. 5 is a flowchart of another process of GenAI-enabled and augmented user research using synthetic personas as subjects, in accordance with embodiments of the present invention.

FIGS. 6A-6C depict an example of an implementation of a user research augmentation system that performs the operations in the flowchart of FIG. 3, in accordance with embodiments of the present invention.

### DETAILED DESCRIPTION

### Overview

User research is time-consuming, expensive, and is complicated by the necessity to find representative sample users. Human focus groups are expensive, time-consuming, and resource-intensive. Furthermore, researchers do not always have easy access to human users. It is not feasible for user researchers to have their human research subjects interact with each other over extended periods of time and generate and test ideas. Experiments that user researchers can run are limited because their human subjects remember previous iterations, changes in variables, etc. Companies struggle to appeal to a new geographic location and/or culture, because of difficulties in not only empaneling a truly representative human focus group, but also knowing the right questions to ask members of the focus group. User researchers have limited visibility into the thinking and reasoning modalities of their human focus groups and test subjects.

Many conventional approaches for an organization's user research use humans as focus group participants (i.e., do not cast bots as focus group participants). The focus groups having human participants are prone to problems because of biases and motivations of the human participants, which may not align with the goals of the organization.

Embodiments of the present invention address the aforementioned unique challenges by integrating expertise evaluation and synthetic persona generation to address identified gaps in expertise and demographic representation in user research, thereby ensuring targeted improvements in the user research results, rather than only providing a creation of diverse persona. In one embodiment, one or more synthetic personas are generated to participate in focus groups for user research directed to a product or service (e.g., testing the reaction of a synthetic persona to a design of a product). As used herein, a synthetic persona is defined as a GenAI-generated profile that simulates a user of a product or service. A synthetic persona is generated based on experiences modeled on existing humans or is given a human background or history. In one embodiment, a synthetic persona is based on GenAI models (e.g., large language models (LLMs)) that have been trained on large amounts of data about humans. Synthetic personas are also known as synthetic users, virtual personas, virtual users, persona bots, and synthetic humans.

Embodiments of the present invention provide interactions among synthetic personas that have different ways of thinking and learning, where the interacting synthetic personas generate and test ideas and results, which optimize products and/or services for success in the market. In one embodiment, the interactions among the synthetic personas are included in a conversation among the synthetic personas, where one or more synthetic personas contribute to the conversation by generating feedback that builds upon previous contributions to the conversation by one or more other synthetic personas.

In one embodiment, the synthetic personas provide feedback that is not limited to an assessment of current characteristics of a product or service, but rather imagines new characteristics of a product or service that are not currently existing, but could be provided in the future.

In one embodiment, multiple versions of each synthetic persona are provided, the multiple versions for a given synthetic persona each possessing the same underlying, but having different modalities of thinking and/or learning.

In one embodiment, the GenAI-enabled user research augmentation approach disclosed herein runs multiple user research scenarios at scale with consistently-available synthetic personas, and provides customized demographic representation in the user research by weighting, quantifying, duplicating, and scoring comprehensive data including individual profile data, product feature data, company metadata, and historical data.

In one embodiment, the GenAI-enabled user research augmentation approach disclosed herein uses a “forget-me-bot” feature to revert a state of any synthetic persona to a state that the synthetic persona had at any particular earlier phase of an evaluation (i.e., earlier than the current phase of the evaluation) and modify one variable at a time to run experiments. In one embodiment, the aforementioned reversion to the state of the synthetic persona at an earlier phase includes resetting the synthetic persona to selectively forget aspects of an experiment included in the evaluation (e.g., forget points of a previous discussion about a product or service), where the experiment was conducted after the aforementioned earlier phase, thereby preventing bias that an actual human would have if the actual human was a subject in the user research. The bias of the actual human is based on the human not being able to truly forget the aspects of the previous experiment in which the human participated.

In one embodiment, the GenAI-enabled user research augmentation approach disclosed herein provides actionable recommendations based on a comprehensive evaluation of both individual and group expertise, thereby ensuring practical improvements in team performance and diversity.

In one embodiment, the GenAI-enabled user research augmentation approach disclosed herein includes a continuous feedback loop for model improvement, which integrates specific expertise and diversity assessments with practical recommendations for targeted training and recruitment.

In one embodiment, the GenAI-enabled user research augmentation approach disclosed herein provides feedback from synthetic personas that simulate users in one or more selected international locations and/or having one or more selected cultural backgrounds. In one embodiment, a modified or new synthetic persona simulates a “move” of an initial synthetic persona to a new geo-location, where the modified or new synthetic persona includes new cultural characteristics associated with the new geo-location, while still retaining underlying characteristics and behaviors that were included in the initial synthetic persona. In one embodiment, the user research approach disclosed herein includes generating synthetic personas that simulate users located in a geo-location selected from among multiple geo-locations (or that simulate users having a selected cultural background), and performing an evaluation of areas of focus associated with a product or a service includes using the synthetic personas to obtain feedback about the product or the service from the synthetic personas. The obtained feedback is based at least in part on the geo-location in which the users being simulated by the synthetic personas are located (or based at least in part on the selected cultural background). Performing the aforementioned evaluation of the areas of focus further includes generating a recommendation to modify the product or the service based on the obtained feedback and the geo-location, where the recommendation is generated exclusively for users located in the geo-location and not for other users located in other geo-locations.

In one embodiment, an evaluation of a product or service by the GenAI-enabled user research augmentation approach disclosed herein includes running an experiment that (i) analyzes a comparison of first recommendations from first synthetic personas in a first geo-location (or having a first cultural background) to second recommendations from second synthetic personas in a second geo-location (or having a second cultural background) and (ii) based on the analysis in (i), recommends changes in the product or the service as based on the first recommendations exclusively for users in the first geo-location (or for users having the first cultural background) and/or recommends changes in the product or the service based on the second recommendations exclusively for users in the second geo-location (or for users having the second cultural background).

In one embodiment, the GenAI-enabled user research augmentation approach disclosed herein creates fine-tuned variations in the synthetic personas in terms of experiences, expertise, cultural background, learning and thinking modalities, and/or levels of knowledge, and determines the effects of the variations on the feedback and recommendations resulting from the user research. For example, a synthetic persona can be generated to have no previous experience with using a product, and can subsequently be modified to have the experience of a long-time user of the product. In one embodiment, multiple experiments are run multiple times with the aforementioned variations and with a degree of randomness to obtain statistically significant trends relative to the user research feedback.

In one embodiment, by using explainable and traceable AI, the user research augmentation approach disclosed herein obtains feedback from a synthetic persona, where the feedback has verifiable truthfulness and completeness. This truthful and complete feedback from the synthetic persona is distinguished from feedback of questionable truthfulness, completeness, and/or candidness from a real human, because the human may have a motivation to be untruthful, withhold some information, and/or be less than candid (e.g., to tell researchers what and how much the human thinks the researchers want to hear because the human wants to be invited to participate in subsequent research).

In one embodiment, synthetic personas are generated in a sufficient number to set up a digital twin of every user in an entire population of users, thereby providing more accurate and reliable user research results (i.e., more accurate and reliable than the statistical sampling required by conventional approaches that rely only on a sample of the users).

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

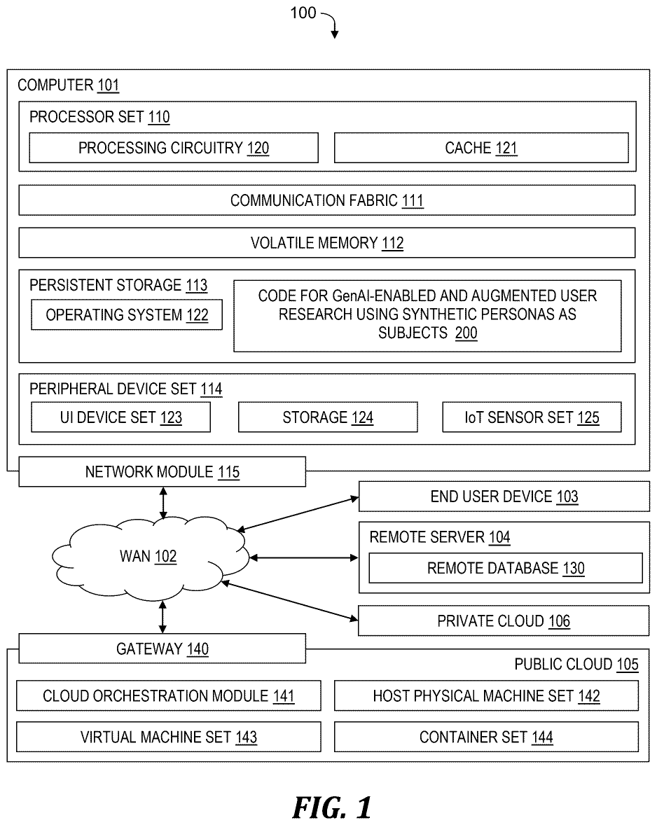

FIG. 1 is a block diagram of a system for GenAI-enabled and augmented user research, in accordance with embodiments of the present invention. Computing environment 100 contains an example of an environment for the execution of at least some of the computer code involved in performing the inventive methods, such as code 200 for GenAI-enabled and augmented user research using synthetic personas as subjects. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for AI-Enabled and Augmented User Research

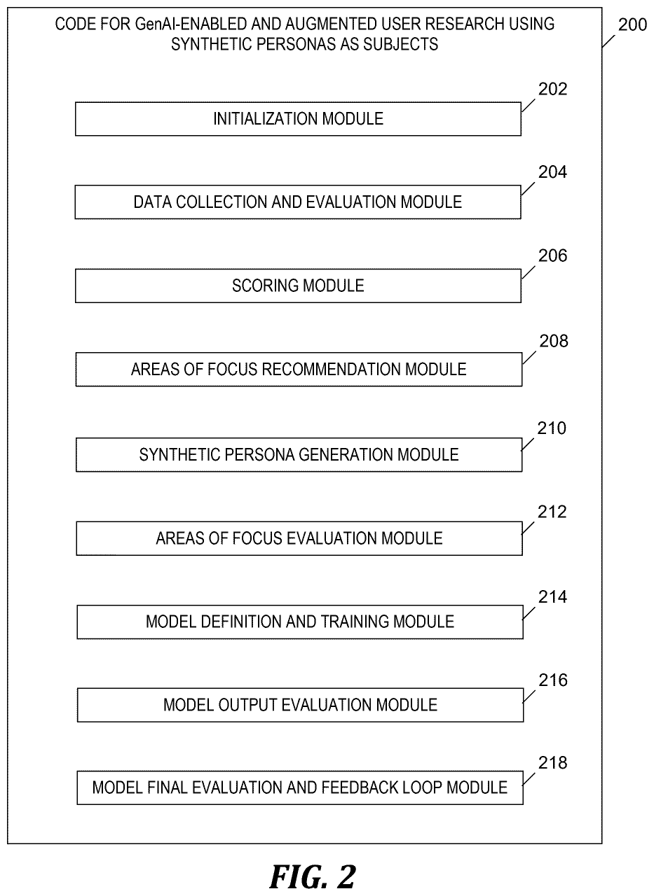

FIG. 2 is a block diagram of modules included in code included in the system of FIG. 1, in accordance with embodiments of the present invention. Code 200 includes an initialization module 202, a data collection and evaluation module 204, a scoring module 206, an areas of focus recommendation module 208, a synthetic persona generation module 210, an areas of focus evaluation module 212, a model definition and training module 214, a model output evaluation module 216, and a model final evaluation and feedback loop module 218.

Data collection and evaluation module 202 is configured to collect data for user research for a product or a service.

Initialization module 202 is configured to define an objective (i.e., a subject or a topic) for user research. In one embodiment, the user research includes an evaluation of a user experience or a user interface.

Data collection and evaluation module 204 is configured to collect and evaluate data from different categories related to the product or service. In one embodiment, the categories include individual profile data, feature data, company metadata, and historical data. The individual profile data includes name, age, gender, expertise, experience, demographics, and behavioral traits of users of the product or service. The feature data includes a type, features, a target audience, a market segment, a life cycle stage, and competitors of the product or service. The company metadata includes an industry, size, market position, rating(s) of historical campaign(s), a brand perception, goals, and values of a company that makes or provides the product or service. The historical data includes previous campaign(s), audience feedback, sales data, sales channel(s), segmentation, and success factors related to historical sales of the product or service.

Scoring module 206 is configured to compute fit scores by an analysis of the data collected by data collection and evaluation module 204, where the analysis provides, for example, expertise relevance, demographic alignment, product feature suitability, and historical data performance. Scoring module 206 is further configured to compute the fit scores by using metrics including relevance percentage, audience match, market position strength, and/or feedback positivity. Scoring module 206 is further configured to analyze and aggregate the aforementioned fit scores to provide an overall fit score and describe and score strengths (i.e., positives) and weaknesses (i.e., areas for improvement).

Areas of focus recommendation module 208 is configured to generate recommendations specifying area(s) of focus and/or question(s) that a user needs to address to complete an evaluation of the product or service, where the evaluation uses the expertise of the user. The aforementioned recommendations generated by areas of focus recommendation module 208 are based on the aggregated fit score (i.e., the overall fit score), the strengths, and the weaknesses provided by scoring module 206.

Synthetic persona generation module 210 is configured to generate one or more synthetic personas which are configured to evaluate the area(s) of focus and/or questions whose recommendation(s) are generated by areas of focus recommendation module 208. In one embodiment, the generation of the synthetic persona(s) is based on the individual profile data collected by data collection and evaluation module 204.

Areas of focus evaluation module 212 is configured to evaluate the area(s) of focus and/or questions by using the one or more synthetic personas generated by synthetic persona generation module 210.

Model definition and training module 214 is configured to define an architecture of a structured model, including layers such as input, encoder, self-attention, and output. Model definition and training module 214 is further configured to train the structured model using an iterative optimization algorithm that minimizes loss during the training of the structured model. For example, model definition and training module 214 trains the structured model using the Adaptive Moment Estimation (ADAM) optimizer, specific loss functions, and conducted over 50-100 epochs. Model definition and training module 214 is further configured to evaluate the performance of the structured model using metrics, such as precision, recall, F1-score, and area under the curve (AUC).

Model output evaluation module 216 is configured to use AI analysis to evaluate outputs of the structured model. The AI analysis includes assessing expertise adequacy, detecting biases, identifying gaps in demographic representation, and identifying gaps in expertise. Synthetic personal generation module 210 is further configured to generate synthetic persona(s) to fill the aforementioned identified gaps and mitigate the aforementioned biases, thereby ensuring a balanced and comprehensive dataset.

Model final evaluation and feedback loop module 218 is configured to ensure that the structured model meets all requirements by reassessing group homogeneity and harmony, improving the aforementioned scores, and achieving desired outcomes. Model final evaluation and feedback loop module 218 is further configured to complete the user research augmentation process with a feedback loop, which continuously improves the structured model by updating the model with new data from ongoing campaigns and studies, and incorporating feedback for refinement and enhancement.

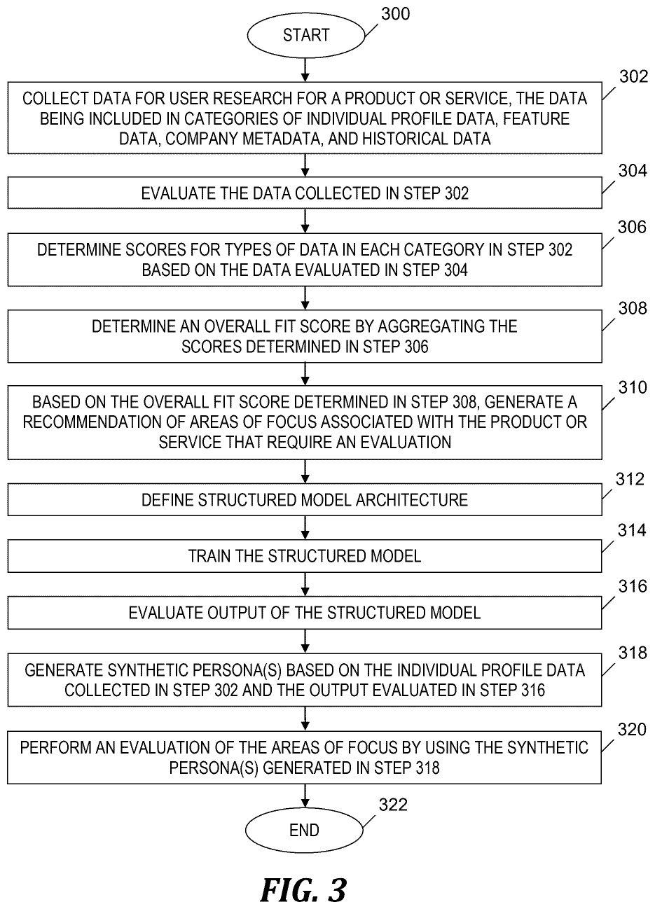

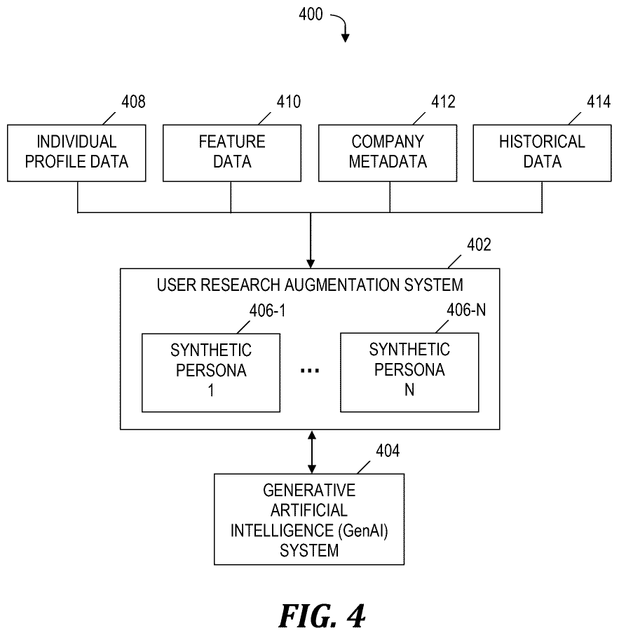

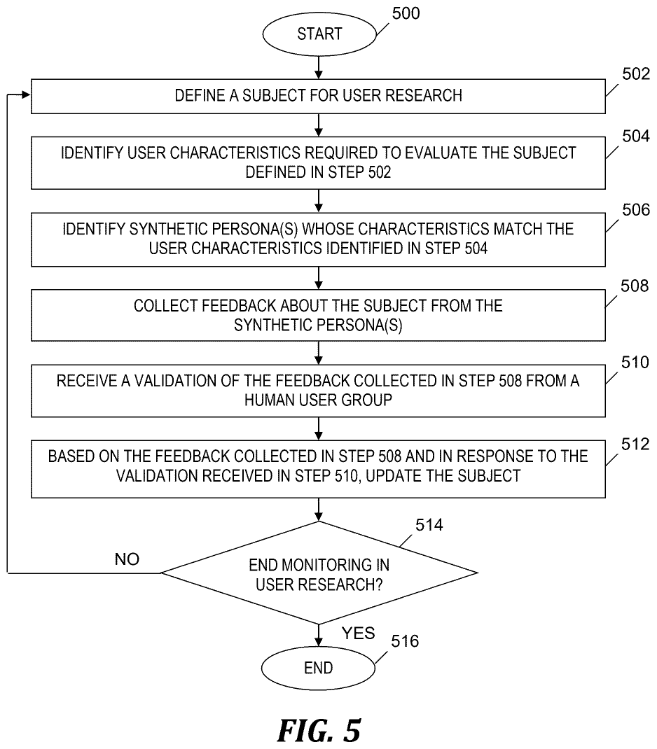

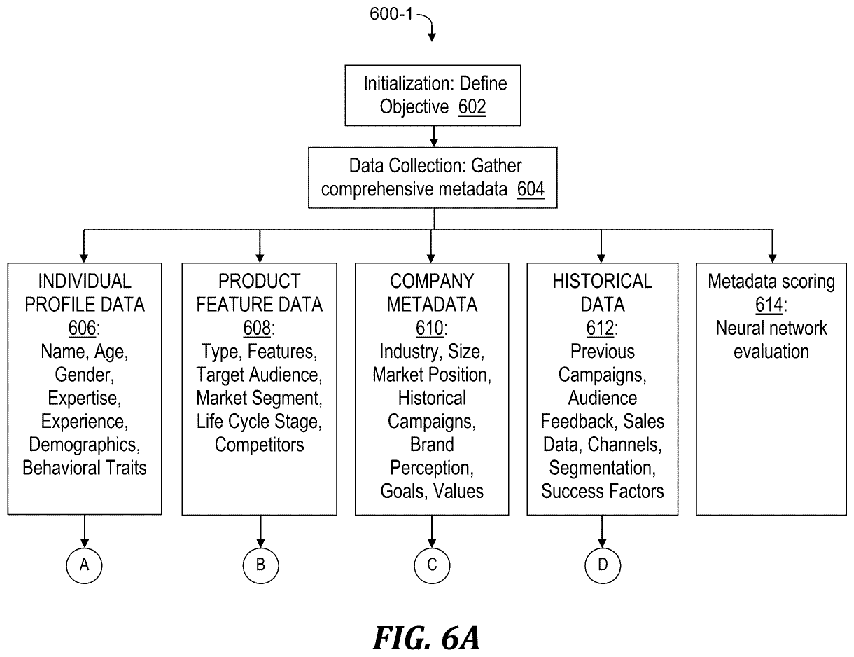

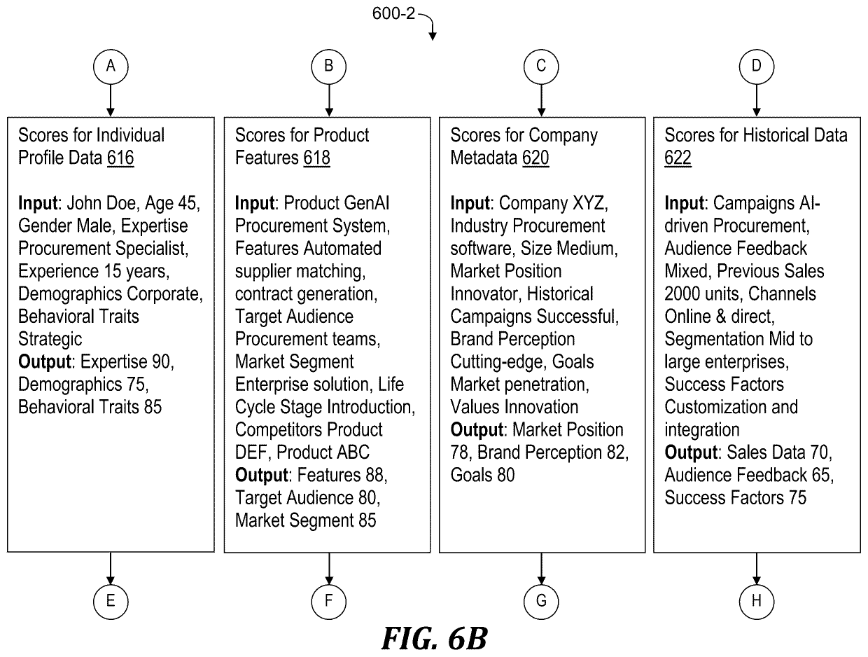

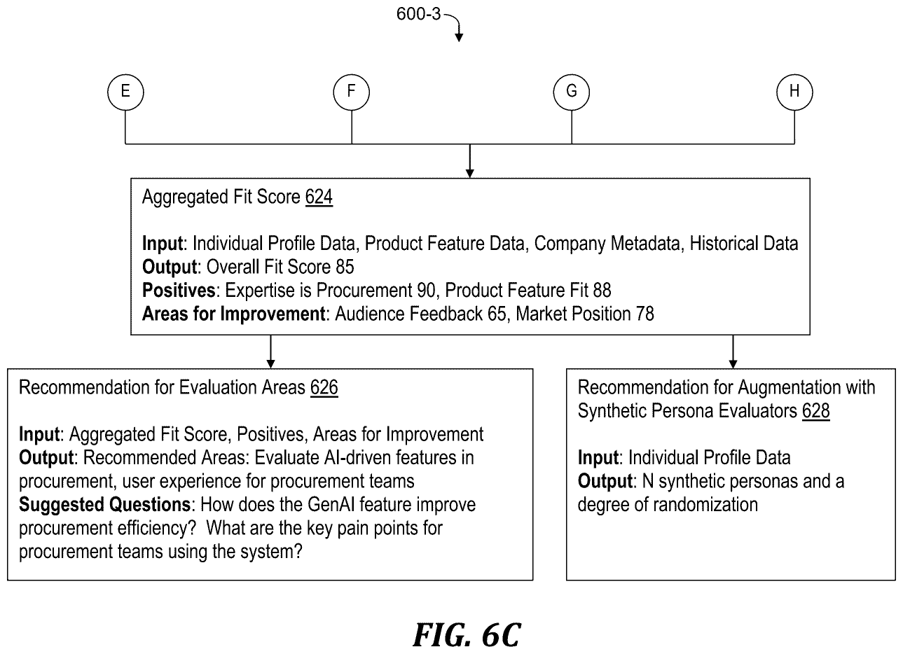

The functionality of the modules included in code 200 is described in more detail in the discussions presented below relative to FIG. 3, FIG. 4, FIG. 5, and FIGS. 6A-6C.

FIG. 3 is a flowchart of a process of GenAI-enabled and augmented user research, where operations of the flowchart are performed by modules in FIG. 2, in accordance with embodiments of the present invention. The process of FIG. 3 begins at a start node 300. In step 302, data collection and evaluation module 204 collects data for user research for a product or a service, where the data is included in the categories of (i) individual profile data, (ii) feature data, (iii) company metadata, and (iv) historical data.

In step 304, data collection and evaluation module 204 evaluates the data collected in step 302 (e.g., analyze factors, such as expertise relevance, demographic alignment, product feature suitability, and historical data performance, using metrics, such as relevance percentage, audience match, market position strengths, and feedback positivity).

In step 306, based on the evaluation performed in step 304, scoring module 206 determines scores for types of data in each category in step 302.

In step 308, scoring module 206 determines an overall fit score by aggregating the scores determined in step 306.

In step 310, based on the overall fit score determined in step 308, areas of focus recommendation module 208 generates a recommendation of area(s) of focus and/or question(s) associated with the product or service, where the area(s) of focus and/or question(s) require an evaluation.

In step 312, model definition and training module 214 defines the architecture of a structured model, including layers, such as input, encoder, self-attention, and output.

In step 314, model definition and training module 214 trains the structured model. The training, for example, uses the ADAM optimizer and specific loss functions, and is conducted over 50 to 100 epochs.

In step 316, model output evaluation module 216 evaluates the output of the structured model via AI analysis, which includes assessing expertise adequacy, detecting biases, identifying gaps in demographic representation, and identifying gaps in expertise.

In step 318, synthetic persona generation module 210 generates synthetic persona(s) to fill the demographic representation and/or expertise gaps identified in step 316 and mitigate the biases detected in step 316. The filling of the identified gaps and mitigation of the biases ensures a balanced and comprehensive dataset.

In step 320, areas of focus evaluation module 212 performs an evaluation of the aforementioned area(s) of focus and/or question(s) whose recommendation is generated in step 310, where the evaluation is performed by the synthetic persona(s) generated in step 318.

After step 320, the process of FIG. 3 ends at an end node 322.

FIG. 4 is a block diagram of a system 400 that implements the process of FIG. 3, in accordance with embodiments of the present invention. System 400 includes a user research augmentation system 402 and a GenAI system 404. User research augmentation system 402 includes synthetic persona 406-1, . . . , synthetic persona 406-N (i.e., synthetic persona 1, . . . , synthetic persona N), where N is an integer greater than or equal to one, and where the N synthetic personas are generated by GenAI system 404.

User research augmentation system 402 defines an objective of user research about a product or a service. User research augmentation system 402 collects individual profile data 408, feature data 410, company metadata 412, and historical data 414, where the collected data is described above relative to the discussion of the data collection and evaluation module 204 in FIG. 2.

User research augmentation system 402 includes a scoring tool (not shown) that uses a neural network (not shown) to score categories of data corresponding to individual profile data 408, feature data 410, company metadata 412, and historical data 414, respectively. To determine the scores, the GenAI system 404 uses the neural network to evaluate aspects including expertise in individual profile data 408, product features in feature data 410, a company's market position in company metadata 412, and historical success in historical data 414.

User research augmentation system 402 computes fit scores by analyzing factors, including (i) expertise relevance and demographic alignment using data collected from individual profile data 408, (ii) product feature suitability using data collected from feature data 410, and (iii) historical performance using data collected historical data 414, including metrics, such as relevance percentage, audience match, market position strength, and feedback positivity.

User research augmentation system 402 aggregates the fit scores to generate an overall fit score, and also generates a description and scoring of strengths and weaknesses. Based on the overall fit score, user research augmentation system 402 generates specific recommendations about which areas and questions the user needs to focus on to utilize the user's expertise effectively in an evaluation of the product or service.

GenAI system 404 defines a structured model architecture that includes layers of input, encoder, self-attention, and output. GenAI system 404 trains the structured model using an optimizer (e.g., ADAM optimizer) and specific loss functions. GenAI system 404 conducts the training of the structured model, for example, over 50-100 epochs. GenAI system 404 evaluates the performance of the structured model using metrics including precision, recall, F1-score, and AUC.

GenAI system 404 analyzes the outputs of the structured model and user research augmentation system 402 evaluates the analysis of the outputs, which includes assessing expertise adequacy, detecting biases, identifying gaps in demographic representation, and identifying gaps in expertise. GenAI system 404 generates synthetic personas 406-1, . . . , 406-N to fill the identified gaps in demographic representation and expertise and to mitigate the detected biases, thereby ensuring a balanced and comprehensive dataset used by user research augmentation system 402.

User research augmentation system 402 performs a final evaluation and harmonization step to ensure that that the structured model meets all requirements by reassessing group homogeneity and harmony, improving the aforementioned scores, and achieving desired outcomes.

User research augmentation system 402 employs a feedback loop that continuously improves the structured model by updating the structured model with new data from ongoing campaigns and studies, and incorporating feedback for refinement and enhancement of the structured model.

FIG. 5 is a flowchart of another embodiment of a process of GenAI-enabled and augmented user research using synthetic personas as subjects, in accordance with embodiments of the present invention. The process of FIG. 5 begins at a start node 500. In step 502, user research augmentation system 402 defines an initial (or next) subject (i.e., topic or area of focus) for user research about a product or a service. A “next” subject is defined in step 502 if step 502 is being performed as part of a subsequent loop, as described below.

In step 504, user research augmentation system 402 identifies user characteristics required to evaluate the subject defined in step 502.

In step 506, user research augmentation system 402 identifies synthetic persona(s) whose characteristics match the user characteristics identified in step 504.

In step 508, user research augmentation system 402 collects feedback about the subject defined in step 502 from the synthetic persona(s) identified in step 506.

In step 510, user research augmentation system 402 receives a validation of the feedback collected in step 508 from a user group consisting of humans.

In step 512, based on the feedback collected in step 508 and in response to the validation received in step 510, user research augmentation system 402 updates the subject defined in step 502 to generate an updated subject for the user research.

In step 514, user research augmentation system 402 determines whether user research augmentation system 402 receives an instruction to end a continuous monitoring in the user research. If user research augmentation system 402 determines that the instruction to end the continuous monitoring has been received, then the Yes branch of step 514 is followed and the process of FIG. 5 ends at an end node 516.

Returning to step 514, if user research augmentation system 402 determines that the instruction to end the continuous monitoring has not been received, then the No branch of step 514 is followed and the process loops back to step 502, with the updated subject generated in the most recent, previous performance of step 512 replacing the subject defined in the most recent, previous performance of step 502. Repeated executions of the loop described above provide the aforementioned continuous monitoring in the user research.

### EXAMPLE

FIGS. 6A-6C depict an example of an implementation of a user research augmentation system that performs the operations in the flowchart of FIG. 3, in accordance with embodiments of the present invention. A first portion 600-1 in FIG. 6A of the example of the implementation of the user research augmentation system includes an initialization 602 that defines the objective of user research about a product and a data collection 604 that gathers comprehensive metadata, which includes individual profile data 606, product feature data 608, company metadata 610, and historical data 612. In one embodiment, the collecting of data in step 302 in FIG. 3 results in data collection 604.

Individual profile data 606 includes name, age, gender, expertise, experience, demographics, and behavioral traits of each user included in multiple users of the product. Product feature data 608 includes a type, features, a target audience, market segment, life cycle stage, and competitors of the product. Company metadata 610 includes an industry, size, market position, ratings of historical campaigns, brand perception, goals, and values of the company that manufactures the product. Historical data 612 includes descriptions of previous campaigns, audience feedback, sales data, sales channels, segmentation, and success factors related to historical sales of the product.

First portion 600-1 also includes metadata scoring 614 that scores each category of data corresponding to individual profile data 606, product feature data 608, company metadata 610, and historical data 612, by using a neural network that evaluates aspects such as expertise, product features, company position, and historical success.

A second portion 600-2 in FIG. 6B of the example of the implementation of the user research augmentation system includes scores for individual profile data 616, scores for product feature data 618, scores for company metadata 620, and scores for historical data 622, where the scores include input from the data collected and shown in FIG. 6A and the output of fit scores generated by metadata scoring 614. For example, scores for individual profile data 616 includes input from individual profile data 606 that includes the name of John Doe, and the age (i.e., 45), expertise (i.e., Procurement Specialist), experience (i.e., 15 years), demographics (i.e., Corporate), and behavioral traits (i.e., Strategic) of John Doe. Scores for individual profile data 616 also includes output from metadata scoring 614 that includes fit scores of 90, 75, and 85 for John Doe for John Doe's expertise, demographics, and behavioral traits, respectively.

Similarly, scores for product feature data 618 include output from metadata scoring 614 that includes fit scores of 88, 80, and 85 for the GenAI Procurement System for features, target audience, and market segment, respectively; scores for company metadata 620 include output that includes fit scores of 78, 82, and 80 for Company XYZ for market position, brand perception, and goals, respectively; and scores for historical data 622 include output that includes fit scores of 70, 65, and 75 for the historical AI-driven Procurement campaign for sales data, audience feedback, and success factors, respectively. In one embodiment, step 306 in FIG. 3 determines the aforementioned fit scores.

A third portion 600-3 in FIG. 6C of the example of the implementation of the user research augmentation system includes a description of an aggregated fit score 624 that includes input of individual profile data 606, product feature data 608, company metadata 610, and historical data 612; output of an overall fit score of 85. The description of the aggregated fit score 624 also includes scores for Positives (i.e., the score of Expertise is Procurement is 90 and the score of Product Feature Fit is 88) and Areas for Improvement (i.e., the score for Audience Feedback is 65 and the score for Market Position is 78). In one embodiment, step 308 in FIG. 3 determines the aggregated fit score 624.

Third portion 600-3 also includes a Recommendation for Evaluation Areas 626, which includes an input of the overall fit score, the Positives, and the Areas for Improvement from the description of the aggregated fit score 624, and further includes an output that includes evaluate AI-driven features in procurement and user experience for procurement teams as Recommended Areas, and Suggested Questions of “How does the GenAI feature improve procurement efficiency?” and “What are the key pain points for procurement teams using the system?” In one embodiment, step 310 in FIG. 3 generates the Recommendation for Evaluation Areas 626, where the areas of focus in FIG. 3 include the evaluation areas in FIG. 6C.

Third portion 600-3 also includes a Recommendation for Augmentation with Synthetic Persona Evaluators 628, which includes an input of individual profile data 606 and an output of one or more synthetic personas and a degree of randomization.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
collecting data for user research for a product or a service, the data being included in a first category of individual profile data for a plurality of users, a second category of product feature data, a third category of company metadata, and a fourth category of historical data;
evaluating the collected data using a neural network;
determining scores for types of data in each category based on the evaluated data;
determining an overall fit score by aggregating the scores;
based on the overall fit score, generating a recommendation of areas of focus associated with the product or service that require an evaluation;
generating, by a processor set, one or more synthetic personas based on the individual profile data; and
performing the evaluation of the areas of focus by using the one or more synthetic personas.

2. The method of claim 1, further comprising:
defining an architecture of a structured model;
training the structured model using an iterative optimization algorithm that minimizes loss; and
evaluating an output of the trained structured model, wherein the evaluating the output includes identifying a gap in an expertise of the plurality of users, the expertise being included in the evaluated collected data, and the gap indicating that the expertise of the plurality of users is inadequate for an evaluation of the areas of focus by the plurality of users, and wherein the generating the one or more synthetic personas is performed in response to the identifying the gap in the expertise of the plurality of users, and includes generating the one or more synthetic personas to include additional expertise that corrects the gap and is adequate for the evaluation of the areas of focus by the one or more synthetic personas.

3. The method of claim 2, wherein the evaluating the output of the trained structured model further includes identifying a gap in a demographic representation of the plurality of users, the demographic representation being specified in the evaluated collected data, and the gap in the demographic representation indicating that the demographic representation of the plurality of users is inadequate for an unbiased evaluation of the areas of focus by the plurality of users, and wherein the generating the one or more synthetic personas is performed in response to the identifying the gap in the demographic representation of the plurality of users, and includes generating the one or more synthetic personas to include additional demographic representation that corrects the gap in the demographic representation and is adequate for an unbiased evaluation of the areas of focus by the one or more synthetic personas.

4. The method of claim 3, further comprising:
performing a final evaluation and harmonization of the structured model by verifying an improvement in the scores; and
performing a feedback loop that updates the structured model with new data based on the evaluation of the areas of focus by the one or more synthetic personas.

5. The method of claim 1, further comprising:
generating multiple synthetic personas based on the individual profile data, the multiple synthetic personas including at least a first synthetic persona and a second synthetic persona; and
collecting information about a conversation among the multiple synthetic personas, wherein the conversation includes a first feedback about the product or the service from the first synthetic persona and a second feedback about the product or the service from the second synthetic persona, the second feedback being based on a processing of the first feedback by the second synthetic persona.

6. The method of claim 1, further comprising:
generating multiple synthetic personas based on the individual profile data, the multiple synthetic personas having different respective modalities of thinking and learning; and
performing the evaluation of the areas of focus by using the multiple synthetic personas based on the multiple synthetic personas having the different respective modalities of thinking and learning.

7. The method of claim 1, wherein the performing the evaluation includes collecting feedback from the one or more synthetic personas, wherein the feedback includes a description of one or more characteristics and a recommendation that the one ore more characteristics be added to the product or the service, and wherein the recommended one or more characteristics do not currently exist in the product or the service.

8. The method of claim 1, wherein the performing the evaluation includes reverting a state of a synthetic persona included in the one or more synthetic personas to a state that the synthetic persona had at an earlier phase in the evaluation, the earlier phase being earlier than a current phase of the evaluation, wherein the reverting causes the synthetic persona to selectively forget aspects of an experiment included in the evaluation, the experiment being conducted subsequent to the earlier phase.

9. The method of claim 1, further comprising:
generating synthetic personas that simulate users located in a geo-location, wherein the performing the evaluation includes:
obtaining feedback about the product or the service from the synthetic personas, the obtained feedback being based at least in part on the geo-location in which the users being simulated by the synthetic personas are located; and
generating a recommendation to modify the product or the service based on the obtained feedback and the geo-location, the recommendation being generated exclusively for users located in the geo-location.

10. A computer system comprising:
a processor set;
one or more computer-readable storage media; and
program instructions stored on the one or more computer-readable storage media to cause the processor set to perform operations comprising:
collecting data for user research for a product or a service, the data being included in a first category of individual profile data for a plurality of users, a second category of product feature data, a third category of company metadata, and a fourth category of historical data;
evaluating the collected data using a neural network;
determining scores for types of data in each category based on the evaluated data;
determining an overall fit score by aggregating the scores;
based on the overall fit score, generating a recommendation of areas of focus associated with the product or service that require an evaluation;
generating one or more synthetic personas based on the individual profile data; and
performing the evaluation of the areas of focus by using the one or more synthetic personas.

11. The computer system of claim 10, wherein the operations further comprise:
defining an architecture of a structured model;
training the structured model using an iterative optimization algorithm that minimizes loss; and
evaluating an output of the trained structured model, wherein the evaluating the output includes identifying a gap in an expertise of the plurality of users, the expertise being included in the evaluated collected data, and the gap indicating that the expertise of the plurality of users is inadequate for an evaluation of the areas of focus by the plurality of users, and wherein the generating the one or more synthetic personas is performed in response to the identifying the gap in the expertise of the plurality of users, and includes generating the one or more synthetic personas to include additional expertise that corrects the gap and is adequate for the evaluation of the areas of focus by the one or more synthetic personas.

12. The computer system of claim 11, wherein the evaluating the output of the trained structured model further includes identifying a gap in a demographic representation of the plurality of users, the demographic representation being specified in the evaluated collected data, and the gap in the demographic representation indicating that the demographic representation of the plurality of users is inadequate for an unbiased evaluation of the areas of focus by the plurality of users, and wherein the generating the one or more synthetic personas is performed in response to the identifying the gap in the demographic representation of the plurality of users, and includes generating the one or more synthetic personas to include additional demographic representation that corrects the gap in the demographic representation and is adequate for an unbiased evaluation of the areas of focus by the one or more synthetic personas.

13. The computer system of claim 12, wherein the operations further comprise:
performing a final evaluation and harmonization of the structured model by verifying an improvement in the scores; and
performing a feedback loop that updates the structured model with new data based on the evaluation of the areas of focus by the one or more synthetic personas.

14. The computer system of claim 10, wherein the operations further comprise:
generating multiple synthetic personas based on the individual profile data, the multiple synthetic personas including at least a first synthetic persona and a second synthetic persona; and
collecting information about a conversation among the multiple synthetic personas, wherein the conversation includes a first feedback about the product or the service from the first synthetic persona and a second feedback about the product or the service from the second synthetic persona, the second feedback being based on a processing of the first feedback by the second synthetic persona.

15. The computer system of claim 10, wherein the operations further comprise:
generating multiple synthetic personas based on the individual profile data, the multiple synthetic personas having different respective modalities of thinking and learning; and
performing the evaluation of the areas of focus by using the multiple synthetic personas based on the multiple synthetic personas having the different respective modalities of thinking and learning.

16. The computer system of claim 10, wherein the performing the evaluation includes collecting feedback from the one or more synthetic personas, wherein the feedback includes a description of one or more characteristics and a recommendation that the one ore more characteristics be added to the product or the service, and wherein the recommended one or more characteristics do not currently exist in the product or the service.

17. A computer program product comprising:
one or more computer-readable storage media; and
program instructions stored on the one or more computer-readable storage media to perform operations comprising:
collecting data for user research for a product or a service, the data being included in a first category of individual profile data for a plurality of users, a second category of product feature data, a third category of company metadata, and a fourth category of historical data;
evaluating the collected data using a neural network;
determining scores for types of data in each category based on the evaluated data;
determining an overall fit score by aggregating the scores;
based on the overall fit score, generating a recommendation of areas of focus associated with the product or service that require an evaluation;
generating one or more synthetic personas based on the individual profile data; and
performing the evaluation of the areas of focus by using the one or more synthetic personas.

18. The computer program product of claim 17, wherein the operations further comprise:
defining an architecture of a structured model;
training the structured model using an iterative optimization algorithm that minimizes loss; and
evaluating an output of the trained structured model, wherein the evaluating the output includes identifying a gap in an expertise of the plurality of users, the expertise being included in the evaluated collected data, and the gap indicating that the expertise of the plurality of users is inadequate for an evaluation of the areas of focus by the plurality of users, and wherein the generating the one or more synthetic personas is performed in response to the identifying the gap in the expertise of the plurality of users, and includes generating the one or more synthetic personas to include additional expertise that corrects the gap and is adequate for the evaluation of the areas of focus by the one or more synthetic personas.

19. The computer program product of claim 18, wherein the evaluating the output of the trained structured model further includes identifying a gap in a demographic representation of the plurality of users, the demographic representation being specified in the evaluated collected data, and the gap in the demographic representation indicating that the demographic representation of the plurality of users is inadequate for an unbiased evaluation of the areas of focus by the plurality of users, and wherein the generating the one or more synthetic personas is performed in response to the identifying the gap in the demographic representation of the plurality of users, and includes generating the one or more synthetic personas to include additional demographic representation that corrects the gap in the demographic representation and is adequate for an unbiased evaluation of the areas of focus by the one or more synthetic personas.

20. The computer program product of claim 19, wherein the operations further comprise:
performing a final evaluation and harmonization of the structured model by verifying an improvement in the scores; and
performing a feedback loop that updates the structured model with new data based on the evaluation of the areas of focus by the one or more synthetic personas.

21. The computer program product of claim 17, wherein the operations further comprise:
generating multiple synthetic personas based on the individual profile data, the multiple synthetic personas including at least a first synthetic persona and a second synthetic persona; and
collecting information about a conversation among the multiple synthetic personas, wherein the conversation includes a first feedback about the product or the service from the first synthetic persona and a second feedback about the product or the service from the second synthetic persona, the second feedback being based on a processing of the first feedback by the second synthetic persona.

22. The computer program product of claim 17, wherein the operations further comprise:
generating multiple synthetic personas based on the individual profile data, the multiple synthetic personas having different respective modalities of thinking and learning; and
performing the evaluation of the areas of focus by using the multiple synthetic personas based on the multiple synthetic personas having the different respective modalities of thinking and learning.

23. The computer program product of claim 17, wherein the performing the evaluation includes collecting feedback from the one or more synthetic personas, wherein the feedback includes a description of one or more characteristics and a recommendation that the one ore more characteristics be added to the product or the service, and wherein the recommended one or more characteristics do not currently exist in the product or the service.

24. A computer-implemented method comprising:
defining an initial subject for user research, wherein the initial subject is required to be evaluated in the user research;
identifying user characteristics that one or more users are required to have to evaluate the initial subject, wherein the user characteristics include (i) levels of experience and expertise associated with using the product or the service, (ii) cultural backgrounds, and (iii) learning and thinking modalities;
identifying one or more synthetic personas whose characteristics match the identified user characteristics;
collecting feedback about the initial subject from the one or more synthetic personas;
receiving a validation of the collected feedback from a user group consisting of humans;
based on the collected feedback and in response to the receiving the validation, updating the initial subject to generate an updated subject; and
repeating the defining, the identifying the user characteristics, the identifying the one or more synthetic personas, the collecting the feedback, and the receiving the validation, with the initial subject being replaced by the updated subject.

25. A computer system comprising:
a processor set;
one or more computer-readable storage media; and
program instructions stored on the one or more computer-readable storage media to cause the processor set to perform operations comprising:
defining an initial subject for user research, wherein the initial subject is required to be evaluated in the user research;
identifying user characteristics that one or more users are required to have to evaluate the initial subject, wherein the user characteristics include (i) levels of experience and expertise associated with using the product or the service, (ii) cultural backgrounds, and (iii) learning and thinking modalities;
identifying one or more synthetic personas whose characteristics match the identified user characteristics;
collecting feedback about the initial subject from the one or more synthetic personas;
receiving a validation of the collected feedback from a user group consisting of humans;
based on the collected feedback and in response to the receiving the validation, updating the initial subject to generate an updated subject; and
repeating the defining, the identifying the user characteristics, the identifying the one or more synthetic personas, the collecting the feedback, and the receiving the validation, with the initial subject being replaced by the updated subject.
